(19) United States
(12) Patent Application Publication
(10) Pub. No.: US 2013/0221546 A1
(43) Pub. Date: Aug. 29, 2013

(54) Flat Sheet Membrane Module

(71) Applicants: Jason C. Christ, Raleigh, NC (US); Justin M. Schreiber, Raleigh, NC (US); Charles H. Guthrie, Raleigh, NC (US); Jeffrey J. Mocock, Raleigh, NC (US); Chinh Q. Hoang, Garner, NC (US)

(72) Inventors: Jason C. Christ, Raleigh, NC (US); Justin M. Schreiber, Raleigh, NC (US); Charles H. Guthrie, Raleigh, NC (US); Jeffrey J. Mocock, Raleigh, NC (US); Chinh Q. Hoang, Garner, NC (US)

(73) Assignee: VEOLIA WATER SOLUTIONS & TECHNOLOGIES SUPPORT, Saint-Maurice (FR)

(21) Appl. No.: 13/408,159

(22) Filed: Feb. 29, 2012

(51) Int. Cl. B01D 69/10; B01D 65/02; B01D 69/06; B01F 3/04; B01D 63/08

(52) U.S. Cl. 261/22; 261/19; 261/20; 210/231; 210/230

(57) ABSTRACT

A flat sheet membrane module is provided and includes a pair of laterally spaced membrane compartments formed therein for receiving and holding two sets of flat sheet membranes. A utility compartment is disposed between the membrane compartments and includes an air conduit for directing air downwardly through the module to air dispersers forming a part of the module or to a separate lower disposed module. Optionally, a permeate conduit may be provided in the utility compartment for channeling permeate from a lower disposed module. A support structure is disposed in each membrane compartment for receiving and holding a set of flat sheet membranes. The support structure includes a pair of plates that sandwich a set of flat sheet membranes together such that the flat sheet membranes of the set are disposed in a side-by-side relationship between the two end plates.

### FIELD OF THE INVENTION

The present invention relates to water and wastewater treatment, and more particularly to a flat sheet membrane module for receiving and holding a series of flat sheet membranes.

### BACKGROUND OF THE INVENTION

Membrane modules typically hold a plurality of membranes, and the entire module is usually placed in a membrane tank that receives water or wastewater being treated. The water or wastewater is circulated through the membrane tank and upwardly through the membrane modules. By applying pressure or a vacuum, the water or wastewater is filtered as it is induced into the membranes, producing a permeate stream which is typically conveyed from the membrane module.

Generally membrane modules of the prior art have a number of drawbacks. First, air and permeate conduits are typically located outside the frame structure of the module. This increases the footprint of the module and, as discussed below, makes the membrane module difficult to employ in an application where it is desired that the membrane module or modules cover substantially the entire cross-sectional area of the membrane tank. Further, in membrane modules of the prior art, membrane sheet compression forces are transferred to the frame structure of the module. In addition, these membrane modules are difficult to properly position in membrane tanks. Often additional equipment is required for in-tank guidance. Also when prior art membrane modules are double stacked, there are often intermediate open areas that permit upwardly moving air and water to escape. Another disadvantage of prior art membrane modules when double stacked is that they are difficult to remove from a tank as a unit without additional equipment.

As noted above, in some cases it is desirable to place membrane modules in a membrane tank such that the membrane modules occupy substantially the entire cross-sectional area of the membrane tank. When this is done, it follows that substantially all of the water or wastewater passing through the membrane tank must pass through the membrane modules. In other words, because the membrane modules occupy substantially the entire cross-sectional area of the membrane tank, there is less chance for a substantial amount of the water or wastewater being treated to bypass the membrane modules. One of the shortcomings or drawbacks of membranes modules of the prior art is that their design does not lend itself to being used in this manner. This is because in many cases certain components of the membrane modules such as the permeate and air conduits lie outside of the basic frame structure of the module. This makes it difficult to fit the module inside a membrane tank such that the respective membrane modules occupy substantially the entire cross-sectional area of the membrane tank.

### SUMMARY OF THE INVENTION

The present invention relates to a membrane module for holding flat sheet membranes wherein the module includes defined sides and wherein components of the module such as permeate manifold, permeate conduit (if present) and air conduit are positioned within the module such that they do not project outwardly through or along the sides of the module. This enables respective sides of the module to be positioned closely adjacent a wall of a membrane tank or enables two or more membrane modules to be positioned closely adjacent to each other.

The membrane module of the present invention effectively divides a group of flat sheet membranes into two sets where each set is independently supported by a support structure within the membrane module. A utility compartment extends between the two sets of membranes. Some of the advantages of this design are as follows. The footprint of the module is reduced. The membrane module of the present invention provides for drop pipes, referred as permeate and air conduits, to extend through the membrane module itself. This adds only the drop pipe diameters to the footprint while pipe fittings, flanges, hose connections, etc. can be moved inboard of the frame, above or below the flat sheet membranes. This saves several inches of footprint per module which adds up to potentially several feet per membrane tank. Providing such utilities inboard the frame structure of the module allows for a “cassette” style frame. In installations where it is desirable for the modules to occupy substantially the entire cross-sectional area of the membrane tank, this design minimizes the gaps between frames which means that little or no water bypass prevention is required. Another advantage of the membrane module of the present invention is that the module does not rely on the frame for the transfer of compression forces to the flat sheet membranes. The module also uses its own legs for intank guidance. The legs of the modules are designed such that each acts as a continuous track for a locating member in the basin to ride on. In one embodiment, the module has a single lifting lug at the center of the module. This eliminate the need to consider the clearances, lifting forces and height restrictions that are present when trying to adapt multiple corner lifting lugs to a single point. When the membrane module of the present invention is double stacked, the design completely closes the interior areas. This prevents the loss of scouring air bubbles and water flow velocity to the upper module, allowing for air scouring rate to potentially be reduced. Even when double stacked, the module design can be lifted as a unit by utilizing one single center lifting lug.

The present invention also relates to a membrane module for receiving and supporting a plurality of side-by-side disposed flat sheet membranes. The module includes one or more membrane compartments and in one embodiment includes two spaced apart membrane compartments. In that embodiment, there is provided a utility conduit that extends vertically between the membrane compartments. The utility conduit houses an air conduit that typically directs air downwardly through the module to air dispersers associated with the module or to a lower disposed module. Optionally, the utility compartment may include a permeate conduit for channeling permeate from a separate lower disposed module. To support the flat sheet membranes, the module is provided with a pair of opposed plates that sandwich a set of sheet membranes in side-by-side relationship between the two plates. In use, water or wastewater being treated flows vertically through the membrane compartment or compartments and some of the water or wastewater is filtered by being induced into the flat sheet membranes where a permeate is produced and eventually withdrawn from the membrane module.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view of the membrane module of the present invention.

FIG. 2 is a perspective detailed view of the area encircled in FIG. 1.

FIG. 3 is a fragmentary perspective view of a top portion of the membrane module.

FIG. 4 is a fragmentary perspective view of a lower portion of the membrane module.

FIG. 5 is an elevation view of one set of flat sheet membranes secured together by a support structure.

FIG. 5A is a fragmentary perspective view illustrating how connecting bars are utilized to hold the flat sheet membranes in compression.

FIG. 5B is a plan view of one of the plates used to support a set of flat sheet membranes.

FIG. 6 is a perspective view that illustrates the basic frame structure of the membrane module.

FIG. 7 is a fragmentary perspective view showing a lower portion of the basic frame structure.

FIG. 8 is a fragmentary perspective view of encircled area 8 in FIG. 6 showing the upper portion of the utility compartment of the membrane module.

FIG. 9 is a perspective view showing a typical flat sheet membrane.

FIG. 10 is a perspective view of a membrane module similar to the one shown in FIG. 1 except that the module shown in FIG. 10 is designed to assume the upper position in a double module stack.

FIG. 11 is a perspective view of a lower portion of the membrane module shown in FIG. 10.

FIG. 12 is a perspective view of two membrane modules double stacked.

FIG. 13 is a perspective exploded view of the double stacked module shown in FIG. 12.

FIG. 14 is a perspective view of the double stacked modules of FIG. 12 but with portions removed to better illustrate the overall structure and configuration of two stacked modules.

FIG. 15 is a side elevational view of the double stacked modules shown in FIG. 12.

FIG. 16 is a perspective view showing two membrane modules and a membrane tank.

### DESCRIPTION OF EXEMPLARY EMBODIMENT

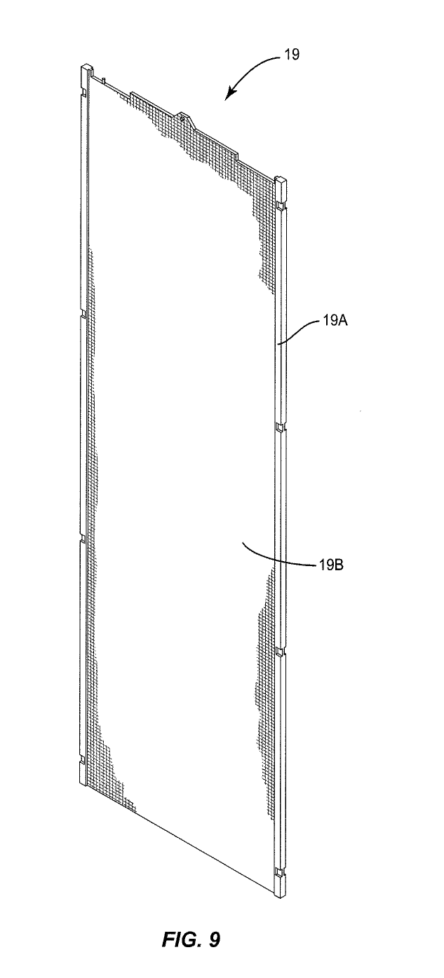

With further reference to the drawings, a membrane module is shown therein and indicated generally by the numeral 10. As will be discussed subsequently herein, membrane module 10 is designed to hold a series of flat sheet membranes 19. See FIG. 9. In particular, the flat sheet membranes 19 are grouped into one or more sets and the one or more sets of flat sheet membranes are supported within the membrane module 10. In the case of the embodiment illustrated herein, the membrane module 10 is designed to receive and hold two sets of flat sheet membranes 19.

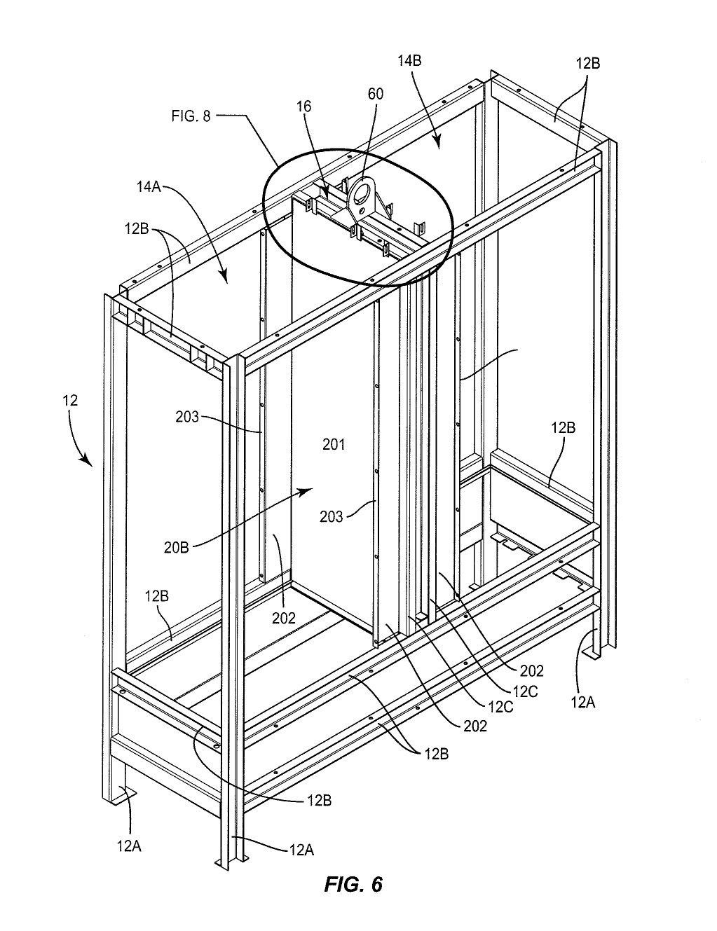

Viewing the membrane module 10 in more detail, the same includes a frame structure indicated generally by the numeral 12. Formed in the membrane module 10 is one or more membrane compartments. In the embodiment illustrated herein, the membrane module 10 is designed to provide two membrane compartments 14A and 14B. See FIG. 6. The membrane compartments 14A and 14B are spaced apart and each compartment is designed to hold and support a set of flat sheet membranes 19. As can be seen from the drawings, each set of flat sheet membranes comprises a series of side-by-side flat sheet membranes 19 that are held in compression within a respective membrane compartment 14A or 14B. The number of flat sheet membranes in each set can vary. In one exemplary embodiment, a set of flat sheet membranes comprises 60 flat sheet membranes disposed in side-by-side relationship. Each membrane compartment 14A or 14B is open at the top and bottom. This permits water and air to flow vertically through each membrane compartment. As will be discussed subsequently herein, the water or wastewater flowing vertically through the respective membrane compartments 14A and 14B will pass between the spaced apart flat sheet membranes 19 supported in the membrane compartments 14A and 14B.

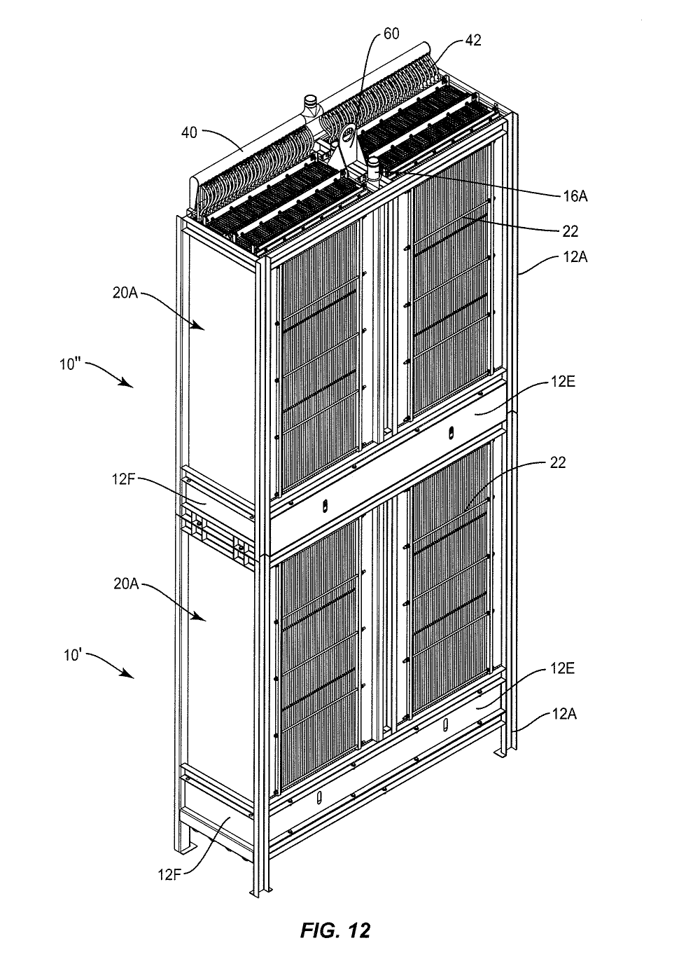

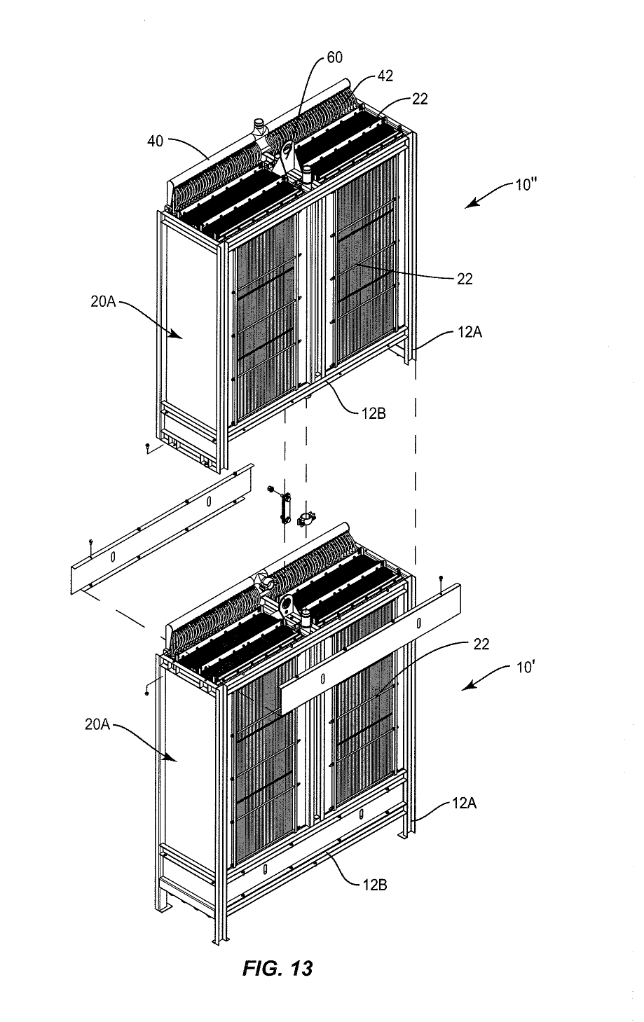

Disposed between the spaced apart membrane compartments 14A and 14B is a utility compartment 16. Utility compartment 16 includes a pair of spaced apart side panels that define an open area in the membrane module 10 generally between the membrane compartments 14A and 14B. As will become apparent from subsequent portions of the disclosure, a part of the support structure for holding the sets of membranes 19 actually form the side panels of the utility compartment 16. To prevent water and air from flowing upwardly through the utility compartment 16, there is provided a bottom plate 16C that effectively seals the utility compartment at the bottom and prevents the upward flow of water and air through the utility compartment 16. See FIG. 7. As will be appreciated from subsequent portions of the disclosure, the utility compartment 16 includes an air conduit 16A. Air conduit 16A is utilized to channel or direct air downwardly through the membrane module 10. In some cases, the membrane module 10 includes a permeate conduit 16B. In some embodiments, the membrane modules 10 are stacked one over the other and in this case a permeate conduit 16B is included in the utility compartment 16 of an upper disposed membrane module in order to channel permeate from a lower disposed module. See FIGS. 12-15.

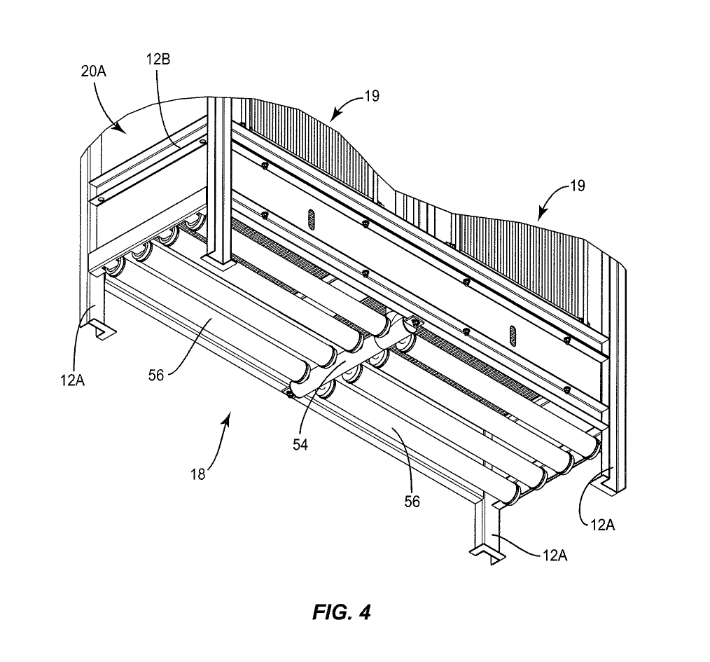

Membrane module 10 (when not stacked or when it forms the lower module of a stack) is provided with an air supply system that disperses air about a lower portion of the membrane module after which the air moves upwardly through the membrane compartments and functions to scour or clean the outer exposed surfaces of the flat sheet membranes 19. In this regard, the membrane module 10 can be provided with air dispersers, indicated generally by the numeral 18, disposed about a lower portion of the membrane module. See FIG. 4. Details of the air dispersers 18 will be dealt with subsequently herein. Suffice it to say that air dispersers 18 will be incorporated into a membrane module 10 if that module is the lowermost module in a stack or if the module is a stand alone module. As will be discussed later, if the module 10 is employed as an upper module in a stack, then it will not be provided with the air dispersers 18.

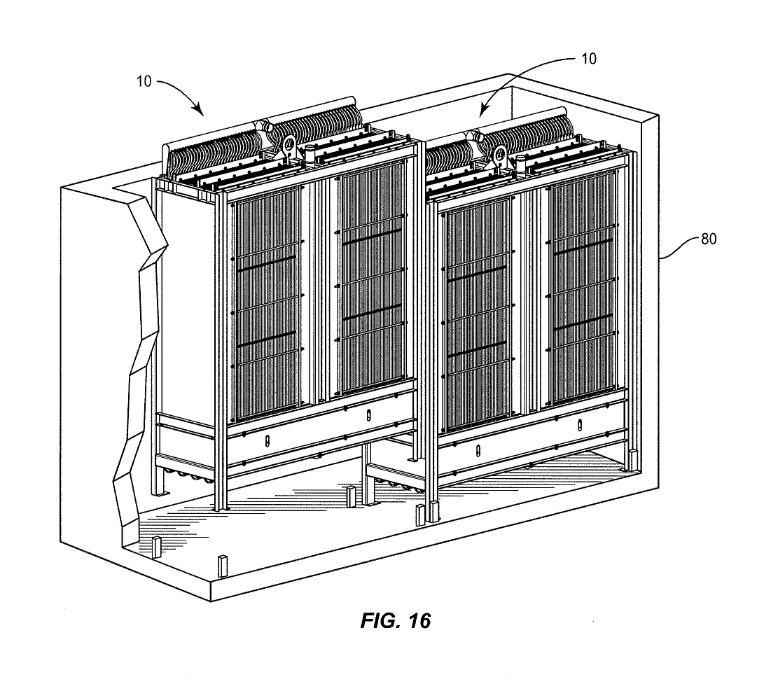

Returning to the frame structure 12, this structure comprises a box or open frame which is rectangular or square. See FIGS. 6-8. The frame structure 12 includes front and back sides and two ends. Forming a part of the frame structure 12 is four vertical corner members 12A. Each vertical corner member 12A is formed in a U-shape for receiving guides disposed in a membrane tank. That is, in some cases, vertical upstanding guides are strategically placed in a membrane tank with the guides designed to fit within the U-shaped corner members 12A of the membrane module 10. See FIG. 16. Membrane module 10 can be suspended over and aligned with the guides and thereafter lowered into the membrane tank 80. The guides of the membrane tank will extend into and through the U-shaped corner members 12A to precisely position the membrane module 10 in the correct location within the membrane tank. In addition to the vertical corner members 12A, the frame structure includes a series of horizontal members 12B formed about the front, back and ends of the module 10. In addition, the frame structure 12 includes a series of intermediate vertical members 12C. Note in FIG. 6 where there is provided two spaced apart intermediate vertical members 12C. Like vertical members are provided about the back of the module 10. Vertical members 12C on the front and back of the module 10 extend parallel to the corner members 12A and connect to upper and lower horizontal members 12B on the front and back of the membrane module 10.

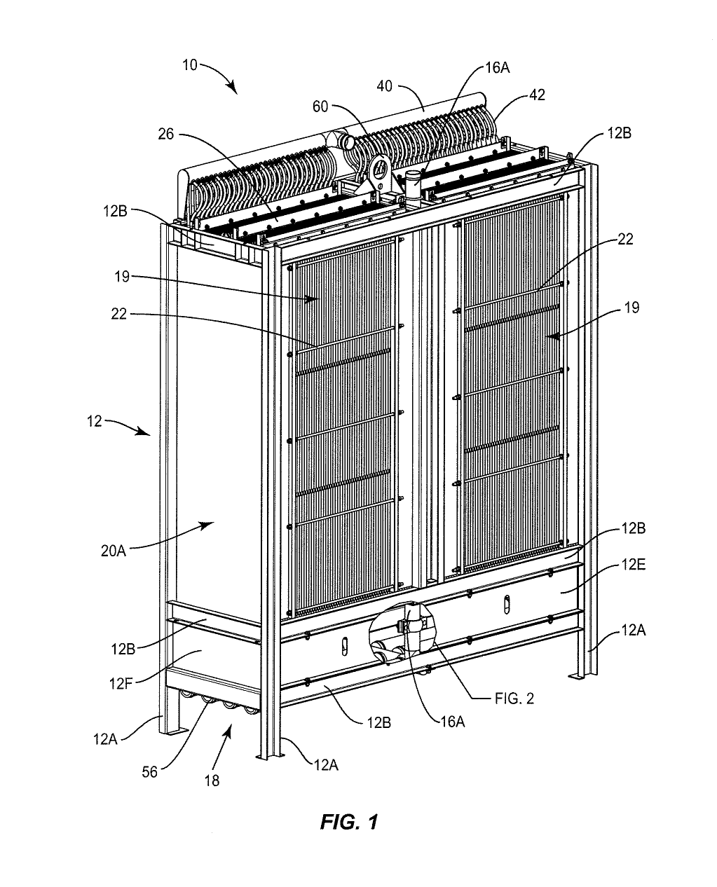

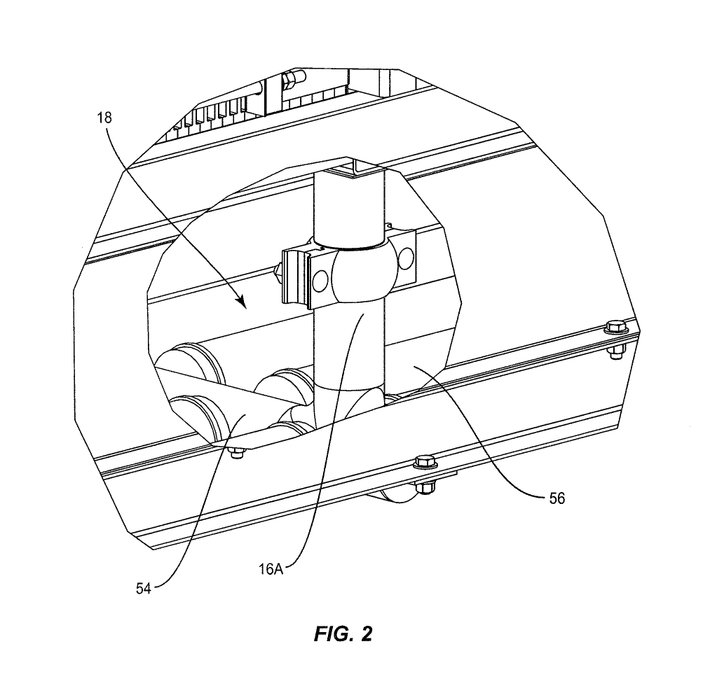

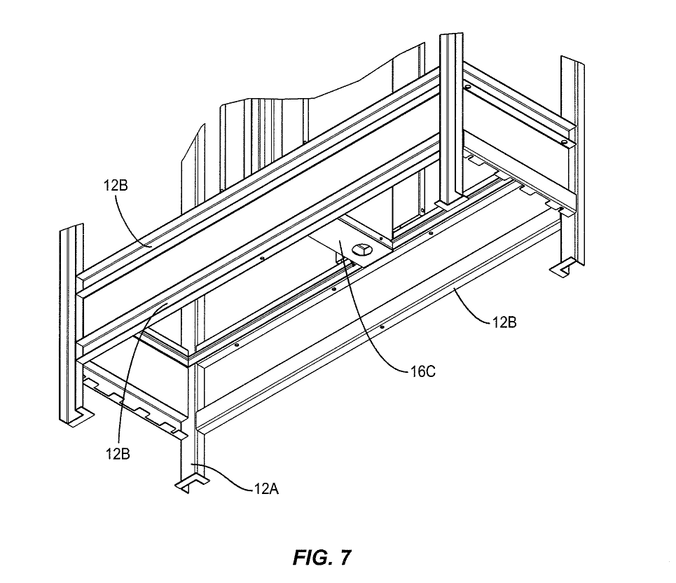

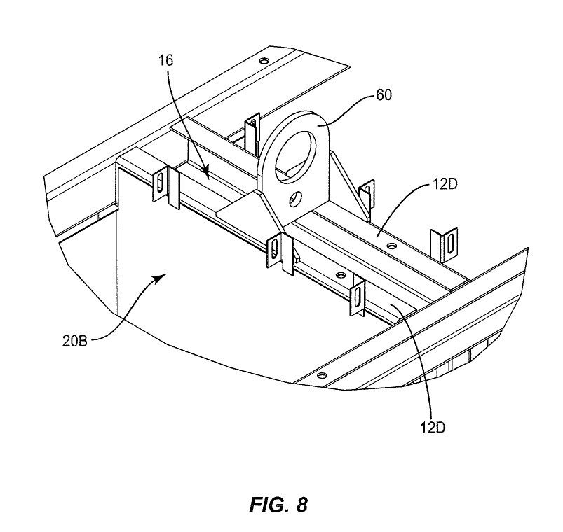

There can be provided other structural members that form a part of the frame structure 12. For example, in the embodiment shown herein, there are two front-to-back members 12D disposed in the upper portion of the utility compartment 16. See FIG. 8. As will be appreciated in subsequent discussions, a number of panels can be secured to various portions of the frame structure 12 so as to enclose portions thereof and which generally function to confine water or wastewater within the module 10 as the water or wastewater moves vertically through the module. Some of these panels will be fixed to the frame structure 12 while other panels are deemed access panels and can be readily detached from the frame structure 12. As illustrated in FIG. 1, the module 10 would include front and/or back detachable access panels 12E. See also FIG. 12. This permits access to be gained to the lower portion of each module. Also, as noted above, some panels could be fixed to the frame structure such as side panels 12F.

Therefore, as seen in the drawings, the membrane module 10 defines a rectangular or square volume that is bounded by four sides, in this case the front, back and opposed ends of the module 10. One of the features of the membrane module 10, which will be appreciated from subsequent portions of this disclosure, is that various components incorporated into the membrane module 10 are confined within these sides. That is, components such as an air supply conduit or permeate conduit extend vertically through the membrane module 10 itself as opposed to lying outside of the module or penetrating the sides of the module.

As discussed above, membrane module 10 is designed to hold and support flat sheet membranes 19. The flat sheet membranes are grouped in sets. Membrane module 10 can receive and hold one or more sets of flat sheet membranes. In the embodiment illustrated herein, the membrane module 10 is designed to receive and hold two sets of flat sheet membranes 19, one set in each membrane compartment 14A or 14B. Details of the flat sheet membrane are not dealt with herein in detail because such is not per se material to the present invention and further flat sheet membranes are commercially available and well known and appreciated by those skilled in the art. A brief description of a flat sheet membrane may be in order. A flat sheet membrane 19 as shown in FIG. 9 includes a surrounding frame structure 19A which is typically made of plastic. Frame 19A holds and supports two spaced apart membrane sheets 19B. Membrane sheets 19B are spaced apart and define a cavity or permeate space between the two sheets. Typically a vacuum is placed on the cavity defined between the two membrane sheets 19B. Thus, as water or wastewater is moving past the flat sheet membrane 19, some water or wastewater will be induced through the sides of the sheets 19B, filtering the water or wastewater in the process and producing a permeate in the cavity between the membrane sheets 19B. Since the permeate in the cavity between the sheets 19B is subjected to a vacuum, it follows that the permeate is effectively pumped or conveyed from the cavity.

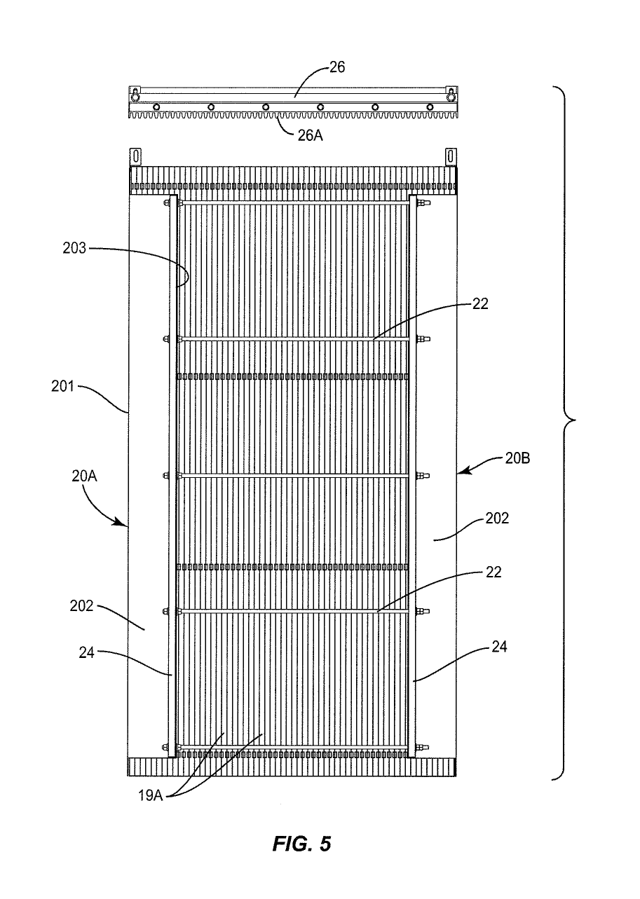

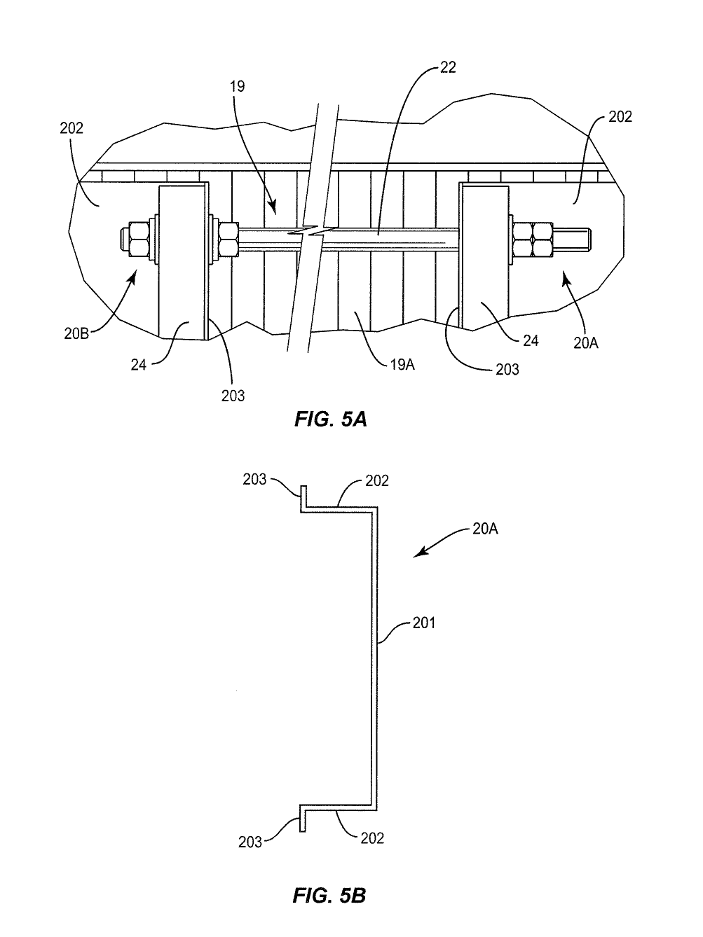

Incorporated into the membrane module 10 is a support structure for receiving and supporting a set of flat sheet membranes 19. This support structure includes a pair of plates 20A and 20B. See, for example, FIGS. 1, 5 and 5B. The set of flat sheet membranes is held in compression between the plates 20A and 20B. Plates 20A and 20B effectively wrap around opposed ends of the set of flat sheet membranes 19. Plates 20A and 20B effectively grip and hold the respective flat sheet membranes 19 of a set in compression. When secured between the plates 20A and 20B, the flat sheet membranes 19 lie in side-by-side relationship and extend from front-to-back in the membrane module 10. Because the plastic frame 19A of the membrane is wider than the space occupied by the two membrane sheets 19B, it follows that there is defined spaces between the respective flat sheet membranes 19 that permits water or wastewater to pass.

Plate 20B is referred to as an inboard plate while plate 20A is referred to as an outboard plate. Inboard plate 20B is fixed with respect to the frame structure 12. That is, the inboard plate 20B can be fixed to the frame structure 12 or to other structural components of the module 10. In fact, in the embodiment illustrated herein, the inboard plate of each set of plates forms a part of the utility cavity 16. That is the inboard plate 20B serves the double function of supporting a set of membranes 19 and at the same time forms one side wall of the utility compartment 16. Plate 20A is termed a floating plate as it is not fixed. Rather plate 20A is moveable with respect to the frame structure 12.

Referring to FIG. 5B, each plate 20A and 20B assumes a generally U-shape. In particular, each plate 20A or 20B includes an end section 201, front and back facing sections 202, and two outwardly extending flanges 203. As seen in the drawings, there is provided a reinforcing bar 24 that extends adjacent each outer flange 203. Plates 20A and 20B are connected together about the front and back of module 10 by a series of connecting bars or rods 22. See, for example, FIGS. 1 and 5A. Connecting rods 22 are threaded on opposite ends and each rod extends through a flange 203 of both plates 20A and 20B and an adjacent reinforcing bar 24. There is provided threaded nuts that thread onto the outer ends of the connecting rods 22. Once these nuts are tightened down, it follows that the flat sheet membranes 19 are held in compression between the two plates 20A and 20B. Note again that plate 20A is a floating plate and is basically supported in cantilever fashion by the fixed plate 20B and the series of connecting rods 22 extending between the two plates 20A and 20B. Opposed side portions of the membrane frames 19A are aligned and held in abutting relationship by the plates 20A and 20B and the connecting rods 22 that effectively cause the side portions of the frames 19A to be gripped between the flanges 203. Since the membrane frames 19A are compressed together, they form opposite sides of a vertical flow channel or conduit. That is the tight relationship between the membrane frames 19A effectively seals opposite sides of this flow channel. Plates 20A and 20B effectively close other portions of the flow channel. Thus, as water or wastewater is moving vertically between the flat sheet membranes 19, the water or wastewater is confined by the plates 20A and 20B and the membrane frames 19A. In this regard, it is appreciated that the frame structure 12 of the module 10 is an open or box frame structure. This means that the module frame structure 12 is open about the front and back sides. Hence the flat sheet membranes 19 are actually exposed about the front and back of the module 10. See FIGS. 1 and 5 for example.

Frames 19A of the respective flat sheet membranes cause the membrane sheets 19B of the respective membranes to be spaced apart from adjacent membrane sheets. To assure that the vertical flow channel between individual flat sheet membranes is maintained at proper spacing, spacers are inserted from the top between respective membrane frames 19A. As seen in FIGS. 1, 3 and 5, there is provided a plurality of spacer support bars 26 that extend transversely across the top of each set of membranes. Secured to the support bar 26 and extending downwardly therefrom is a plurality of spacers 26A. See FIG. 5. These spacers 26A project downwardly between the respective flat sheet membranes 19.

There are other ways of supporting the set of flat sheet membranes 19. That is, there are other approaches for receiving and supporting the flat sheet membranes 19 instead of the compression approach discussed above. One alternative approach is to provide a holding and support structure for receiving and holding a set of flat sheet membranes. One such structure includes a series of slots with each slot adapted and configured to receive one flat sheet membrane 19. Thus the flat sheet membranes 19 would be held in the series of slots in a spaced apart relationship. Thus water and air is free to flow upwardly through and past the respective flat sheet membranes 19 supported in the slots or other holding structure. The advantages to this approach is that the individual flat sheet membranes 19 can be replaced very easily.

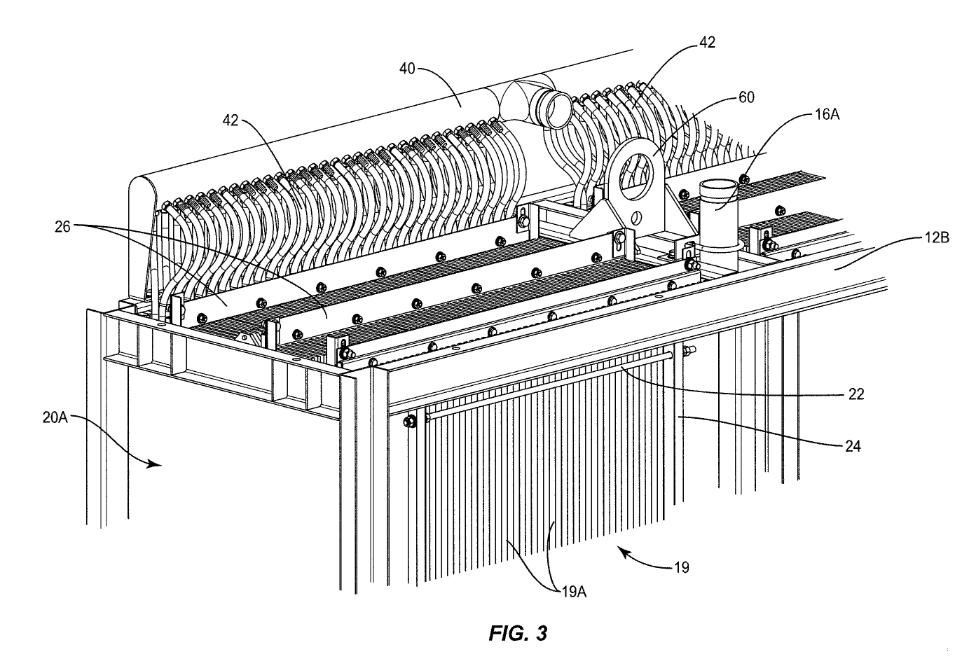

Each membrane module 10 includes a permeate manifold 40 for collecting permeate from the respective flat sheet membranes 19 supported within the module. As seen in FIGS. 1 and 3, there is provided a series of connecting tubes 42 that extend from the respective membranes 19 to the permeate manifold 40. That is, there is a connecting tube 42 that is operatively connected to the permeate space or cavity of each membrane 19 and extends therefrom to the permeate manifold 40. Once the permeate from the respective membranes has collected in the manifold 40, the permeate is conveyed from the membrane module 10 in conventional fashion.

As briefly alluded to earlier, in certain cases the membrane module 10 is provided with an air supply system, and more particularly with air dispersers, indicating generally by the numeral 18, located in a lower or bottom portion of the module 10. The air supply system includes the air conduit 16A that extends downwardly through the utility conduit 16 of the module 10. Disposed about the lower portion of the module is an air manifold 54 that receives air from the air conduit 16A. Branching off from the air manifold 54 is a series of air outlet pipes 56. See FIG. 4. Each outlet pipe 56 includes a pipe having apertures or openings and a rubber sleeve extending around the pipe which also includes openings. Air is generated exteriorly of the module 10 and directed into the air conduit 16A. Once in the air conduit 16A, the air moves through the air conduit downwardly to the air manifold 54. Air is dispersed through the air manifold 54 into the respective outlet pipes 56. Air dispersed out the outlet pipes 56 rises upwardly through the module 10 and between the respective flat sheet membranes 19. As the air moves upwardly between the membranes 19, the air will effectively scour and clean the outer surfaces of the membrane sheets. Further, the upwardly moving air tends to facilitate and encourage the upward movement of water or wastewater through the module 10.

For handling, each module 10 is provided with an upper suspension bracket or lug 60. As seen in the drawings, the suspension lug 16 includes an opening that enables a cable, rope or other supporting device to be connected. Suspension lug 60 is utilized in handling the module and particularly in raising and lowering the module with respect to the membrane tank.

Membrane module 10 is designed to be stacked. See FIGS. 12-15. That is, a plurality of modules 10 can be stacked one over the other. When stacked, various components and sections of the respective modules are aligned. For example, the membrane compartments 14A and 14B, and utility compartment 16 are aligned. FIG. 12 shows two membrane modules stacked, a lower membrane module 10′ and an upper membrane module 10″. It should be pointed out that when the membrane module is designed to be utilized in a stack that the stacked version of the module includes the basic structure and functions described above. However, there are some differences depending on whether the membrane module is intended to assume a lower position in the stack or an upper position within the stack. In all cases, the membrane module includes at least one membrane compartment, at least one set of flat sheet membranes in each compartment 14, a utility compartment, an air conduit 16A in the utility compartment 16 and a permeate manifold, etc. In order to stack two modules, it is understood and appreciated that one module would be bolted or secured by other suitable means to the other module. This securely stations the upper module 10″ over the lower module 10′. In addition, it would permit the two modules to be moved as a unit.

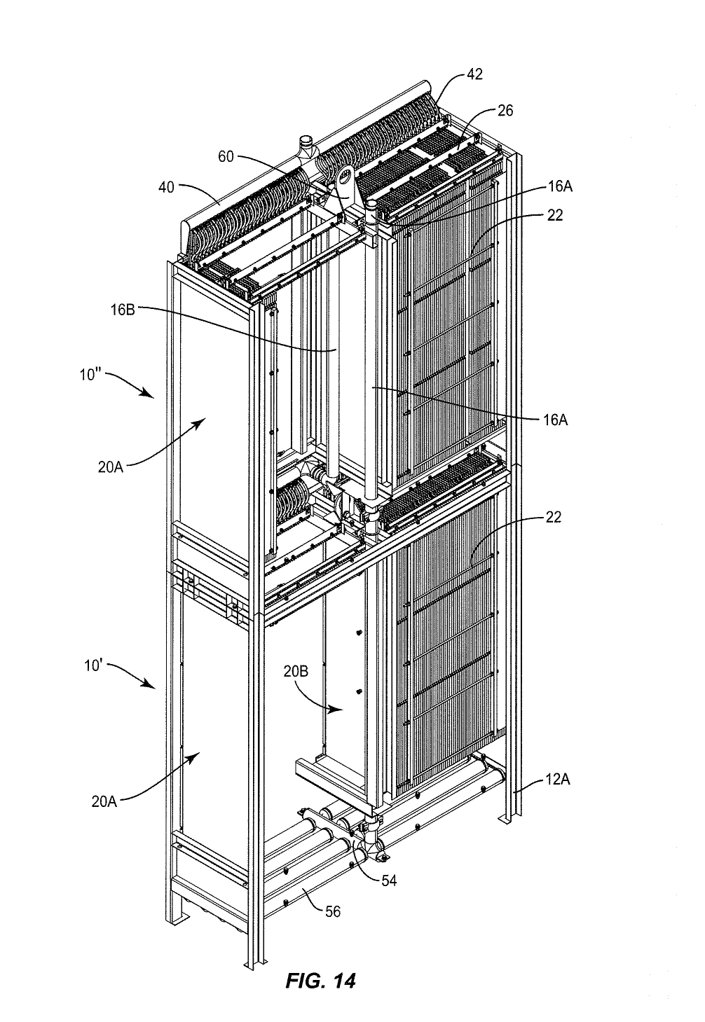

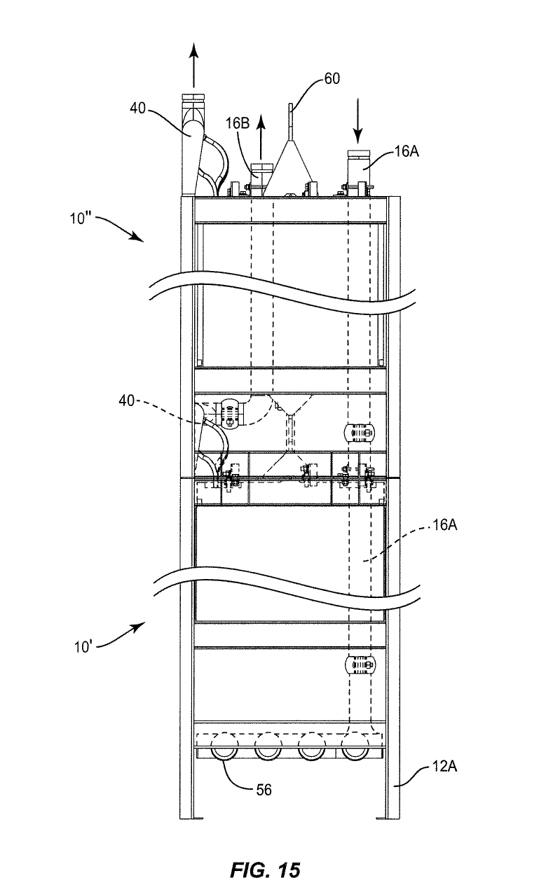

In terms of the air dispersers 18, in a preferred embodiment, only the lowermost module 10′ includes the air dispersers 18. See FIGS. 14 and 15. In many applications, sufficient air can be dispersed about the bottom or lower portion of the lowermost module 10′. However, in this particular embodiment, there would be an air conduit 16A extending through the utility compartment 16 of each module in the stack. The respective air conduits 16A are appropriately coupled such that they are essentially airtight and such that they function to channel air from the upper portion of the upper module 10″ to the air dispersers 18 located in the lower portion of the lowermost module 10′.

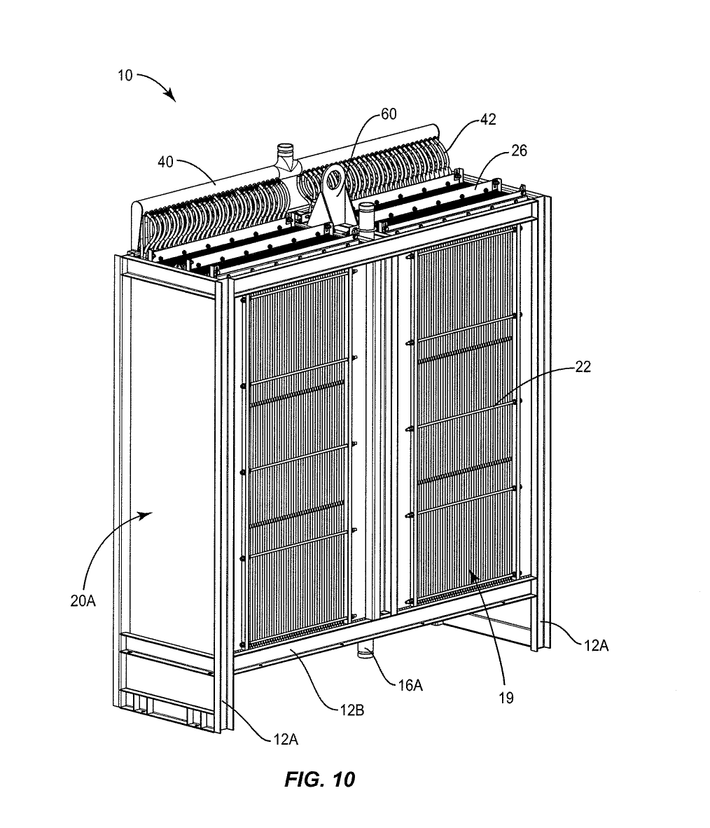

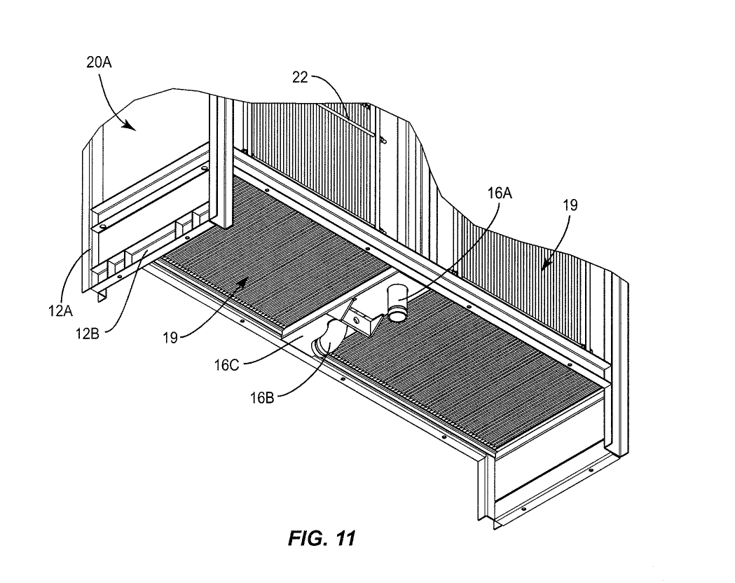

To accommodate the air dispersers 18 in a membrane module, sufficient space below the membranes must be provided for the air manifold 54 and the air outlet pipes 56. Thus for the lowermost module 10′, the space provided below the membranes may be greater than the corresponding space for an upper modules 10″ of the stack. A membrane module configured to assume an upper position in a stack is shown in FIGS. 10 and 11. Note that the space provided by the frame structure 12 of the module shown in FIGS. 10 and 11 is smaller than the corresponding space shown in the module of FIG. 1 which is capable of functioning as a standalone module or the lowermost module in a module stack.

It is also appreciated that the lowermost module 10′ would not be required to have a permeate conduit 16B in the utility compartment 16 thereof. A permeate conduit 16B is only needed in the upper module 10″ for the purpose of conveying the permeate collected by a lowermost module 10. See FIG. 14. Thus in the case of a double stack, only the upper module 10″ is provided with a permeate conduit 16B in the utility compartment 16.

Membrane module 10 of the present invention has many advantages. It can be employed as a standalone unit or, as discussed above, the membrane module can be stacked. In preferred embodiments, the design of the module 10 confines utility components to an internal area of the module. That is, the design enables air and permeate conduits to be confined internally within the module and not extending upwardly adjacent the sides of the module or penetrating through the sides of the modules. This enables the module 10 to fit tightly or closely adjacent a wall of a membrane tank 80 or to fit closely adjacent a like module or a stack of like modules. This, in one embodiment, enables a series of modules 10 to occupy substantially the entire cross-sectional area of a membrane tank which will reduce the amount of water or wastewater that can bypass the modules during treatment. In other words, this assures that a great majority of the water being pumped or moved vertically through a membrane tank passes adjacent the membranes 19. This creates a high packing density. To illustrate this concept, see FIG. 16. This shows two membrane modules 10, of the design shown in FIG. 1, positioned in a membrane tank 80. Note that the two membrane modules 10 will occupy substantially the entire cross-sectional area of the membrane tank 80. It should be noted that the membrane module 10 has other applications and is not required to be utilized in an application where the membrane module or modules occupy substantially the entire cross-sectional area of the membrane tank.

It is noted that the membrane module design forms a column through which the water or wastewater passes as it moves vertically through the module. Note that the plates 20A and 20B in combination with the outer frames 19A of the flat sheet membranes 19 form a surrounding generally closed structure that confines the upward movement of the water or wastewater. In particular, the outer edges of the membrane frames 19A actually form a part of the front and back of each membrane module 10. This contributes to a cost effective construction while at the same time forming a conduit through which the water or wastewater flows as it moves through the module 10.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A flat sheet membrane module comprising:
a frame structure;
a pair of laterally spaced flat sheet membrane compartments formed in the membrane module, each compartment adapted to receive a set of flat sheet membranes;
a utility compartment formed in the membrane module between the membrane compartments;
an air conduit extending through the utility compartment for channeling air downwardly through the utility compartment to a lower portion of the membrane module;
air dispersers disposed in a lower portion of the membrane module for receiving air from the air conduit and dispersing air;
a support structure disposed in each membrane compartment for supporting the set of flat sheet membranes;
the support structure including at least one member moveable relative to the frame structure for compressing the set of membranes together such that the membranes of the set are held in compression; and
a permeate manifold associated with the membrane module for receiving permeate from the respective flat sheet membranes.

2. The flat sheet membrane module of claim 1 wherein the frame structure forms a plurality of sides of the membrane module, and wherein the permeate manifold and air conduit are disposed within the sides of the membrane module.

3. The flat sheet membrane module of claim 1 further including two sets of flat sheet membranes with each set disposed in one membrane compartment and including a plurality of side-by-side flat sheet membranes.

4. The flat sheet membrane module of claim 1 wherein the support structure includes two spaced apart members where at least one member is moveable with respect to the frame structure; and wherein the two members cooperate to hold one set of flat sheet membranes in compression within the membrane module.

5. The flat sheet membrane module of claim 4 wherein the support structure includes a plurality of rods interconnected between the two members and which compress the two members together such that one set of flat sheet membranes are held in compression between the two members.

6. The flat sheet membrane module of claim 5 wherein one member is fixed relative to the frame structure.

7. The flat sheet membrane module of claim 5 wherein one member of the support structure is fixed at a position adjacent the utility compartment and wherein the moveable member is disposed outwardly thereof.

8. The flat sheet membrane module of claim 1 wherein the frame structure defines a rectangular or square envelope having multiple sides and wherein the permeate manifold and air conduit are confined within the envelope.

9. The flat sheet membrane module of claim 1 further including a permeate conduit disposed in the utility compartment for directing permeate through the utility compartment.

10. The flat sheet membrane module of claim 1 wherein the flat sheet membrane module of in claim 1 constitutes a first module, and wherein there is a second flat sheet membrane module having a pair of laterally spaced membrane compartments and a utility compartment formed between the membrane compartments; and
wherein the first and second membrane modules are stacked one over the other such that the membrane compartments and utility compartment of the first membrane module are aligned with the membrane compartments and utility compartment of the second membrane module.

11. The flat sheet membrane modules of claim 10 wherein an uppermost membrane module includes both an air conduit and a permeate conduit disposed in the utility compartment thereof for channeling air and permeate through the utility compartment of the uppermost membrane module.

12. The flat sheet membrane modules of claim 11 wherein a lowermost membrane module includes a permeate manifold that is operatively connected to the permeate conduit disposed in the utility compartment of the uppermost membrane module.

13. A flat sheet membrane module comprising:
a frame structure;
at least one flat sheet membrane compartment disposed in the module for receiving and holding a set of flat sheet membranes with each flat sheet membrane of the set including a frame and two membrane sheets;
a supporting structure associated with the module for holding and supporting the set of flat sheet membranes;
the support structure including two opposed and spaced apart plates, at least one of which is moveable relative to the frame structure;
a series of connectors interconnecting the two plates such that the opposed plates hold the set of membranes in compression between the two plates; and
wherein the opposed plates and frames of the flat sheet membranes form a vertical water flow channel bounded by the plates and the frames of the flat sheet membranes.

14. The membrane module of claim 13 wherein each plate includes an outwardly extending structure that extends outwardly past the flat sheet membranes on opposite sides of the module; and wherein the connectors include a series of bars, each having at least one threaded end portion; wherein the bars are disposed on opposite sides of the set of flat sheet membranes and extend through the outwardly extending structure of each plate; and wherein threaded nuts are secured to the bars which function to connect the bars to the two plates which hold the set of flat sheet membranes in compression.

15. The flat sheet membrane module of claim 13 wherein the connectors comprise a series of bars connected to and extending between the two plates.

16. The flat sheet membrane module of claim 13 wherein each plate comprises a generally U-shape and includes a side section, front and back facing sections, and a pair of outwardly extending flanges.

17. The flat sheet membrane module of claim 16 wherein the connectors include a series of bars that connect to the respective flanges of the two plates.

18. The flat sheet membrane module of claim 13 wherein the module includes two membrane compartments for holding two sets of flat sheet membranes, and wherein the support structure includes two sets of plates with each set of plates holding a set of flat sheet membranes in compression within a respective membrane compartment.

19. The flat sheet membrane module of claim 16 wherein there is provided a reinforcing bar that extends adjacent each flange of each plate.

20. The flat sheet membrane module of claim 18 further including a vertical utility compartment disposed between the two membrane compartments; and an air conduit disposed in the utility compartment for channeling air downward and through the module.

21. A flat sheet membrane module structure, comprising:
(A) a lower flat sheet membrane module comprising:
(1) a frame structure;
(2) a pair of spaced apart flat sheet membrane compartments formed in the lower membrane module, each compartment configured to receive and hold a set of flat sheet membranes disposed in side-by-side relationship;
(3) a utility compartment disposed between the membrane compartments;
(4) a permeate manifold operatively connected to the flat sheet membranes for receiving permeate therefrom;
(5) air dispersers for dispersing air below the flat sheet membranes of the lower module;
(6) an air conduit disposed in the utility compartment for directing air to the air dispersers;
(7) a support structure disposed in each membrane compartment for receiving and holding one set of the flat sheet membranes in compression;
(B) an upper flat sheet membrane module comprising:
(1) a frame structure;
(2) a pair for spaced apart flat sheet membrane compartments forming a part of the upper flat sheet membrane module, each compartment configured to receive and hold a set of flat sheet membranes disposed in side-by-side relationship;
(3) a utility compartment disposed between the membrane compartments of the upper membrane module;
(4) a permeate manifold operatively connected to the flat sheet membranes of the upper membrane module for receiving permeate therefrom;
(5) an air conduit disposed in the utility compartment of the upper membrane module for directing air downwardly through the upper membrane module and to the air conduit disposed in the utility compartment of the lower membrane module;
(6) a permeate conduit disposed in the utility compartment of the upper membrane module and operatively connected to the permeate manifold of the lower membrane module for directing permeate from the lower membrane module upwardly through the upper membrane module;
(7) a support structure disposed in each membrane compartment for receiving and holding one set of the flat sheet membranes in compression; and
(C) the upper flat sheet membrane module being disposed over the lower flat sheet membrane module such that the membrane compartments and utility compartment of the lower membrane module aligns with the membrane compartments and utility compartments of the upper membrane module.

22. The flat sheet membrane module structure of claim 21 wherein the support structure of both lower and upper membrane modules includes two opposed plates, and wherein the two plates in a holding configuration are spaced apart and are operative to hold a respective set of flat sheet membranes in compression between the two plates; and
wherein one of the two plates is moveable with respect to the respective frame structure.

23. The flat sheet membrane module structure of claim 21 wherein the utility compartments of the respective modules are generally closed to prevent water from flowing upwardly through the utility compartments.

24. The flat sheet membrane module structure of claim 21 wherein each membrane module defines a vertical column and wherein the permeate manifolds, air conduits, and permeate conduit of the respective modules are confined within the defined vertical column such that a plurality of sides of the modules can be placed flush against walls of a membrane tank.

25. A flat sheet membrane module comprising:
a frame structure;
a pair of laterally spaced flat sheet membrane compartments formed in the membrane module;
a utility compartment formed in the membrane module between the membrane compartments;
an air conduit extending through the utility compartment to channel air downwardly through the utility compartment;
two sets of flat sheet membranes, one set of flat sheet membranes disposed in each membrane compartment;
a support structure for receiving and supporting each set of flat sheet membranes in a respective membrane compartment; and
a permeate manifold associated with the membrane module for receiving permeate from the respective flat sheet membranes.

26. The flat sheet membrane module of claim 25 wherein the frame structure forms a plurality of sides of the membrane module, and wherein the permeate manifold and air conduit are disposed within the sides of the membrane module.

27. The flat sheet membrane module of claim 26 further including air dispersers disposed in a lower portion of the membrane module for receiving air from the air conduit and dispensing air.

28. The flat sheet membrane module of claim 25 wherein the support structure includes at least one member moveable relative to the frame structure for compressing the set of flat sheet membranes together such that the membranes of each set are held in compression.

29. The flat sheet membrane module of claim 25 wherein the frame structure defines a rectangular or square envelope having multiple sides and wherein the permeate manifold and air conduit are confined within the envelope.

30. The flat sheet membrane module of claim 25 wherein the flat sheet membrane module of claim 25 constitutes a first module, and wherein there is a second flat sheet membrane module having a pair of laterally spaced membrane compartments and a utility compartment formed between the membrane compartment; and
wherein the first and second membrane modules are stacked one over the other such that the membrane compartments and utility compartment of the first membrane module are aligned with the membrane compartments and utility compartment of the second membrane module.

31. The flat sheet membrane modules of claim 29 wherein an uppermost module includes both an air conduit and a permeate conduit extending through the utility compartment thereof for channeling air and permeate through the utility compartment of the uppermost membrane module.

32. The flat sheet membrane modules of claim 30 wherein the lowermost membrane module includes a permeate manifold that is operatively connected to the permeate conduit disposed in the utility compartment of the uppermost membrane module.
